(19) United States
(12) Patent Application Publication
(10) Pub. No.: US 2006/0070579 A1
(43) Pub. Date: Apr. 6, 2006

(54) Method of protecting bird feeder from squirrels

(76) Inventor: Patricia E. Hackley, Fredericksburg, VA (US)

Correspondence Address: OLIFF & BERRIDGE, PLC, P.O. BOX 19928, ALEXANDRIA, VA, 22320, US

(21) Appl. No.: 10/958,261

(22) Filed: Oct. 6, 2004

(51) Int. Cl. A01K 61/02

(52) U.S. Cl. 119/57.9

(57) ABSTRACT

A method of protecting a bird feeder or other location from squirrels includes applying a lubricant, such as petroleum jelly, to and/or around a support, such as a pole on which a bird feeder is mounted or a string or rope from which a bird feeder is suspended.

### BACKGROUND OF THE INVENTION

1. Field of Invention

This invention relates to protecting a desired location from access by squirrels or other animals.

2. Description of Related Art

Many people face the problem of attempting to feed or shelter one form of wildlife, such as birds, but having the food or shelter stolen by another form of wildlife, such as squirrels. Many strategies and devices have been devised to protect bird feeders from squirrels. Many of these involve complex structures, and all appear to-involve either retrofitting some type of guard, such as a squirrel shield, onto an existing feeder, or purchasing a uniquely designed feeder with squirrel-repelling features.

### SUMMARY OF THE INVENTION

This invention provides a very simple yet very effective method for repelling at least squirrels, and possibly other forms of wildlife that would raid a location such as a bird feeder or the like. The method includes applying a lubricant, such as petroleum jelly, to and/or around the location, and preferably to a support of the location, such as a pole on which a bird feeder is mounted or a string or rope from which a bird feeder is suspended.

### DETAILED DESCRIPTION OF PREFERRED EMBODIMENTS

This invention reduces accessibility to a bird feeder or other location by squirrels and/or other animals through application of a lubricant to and/or around the bird feeder or other location.

The method may include applying the lubricant, which may be, for example, petroleum jelly, such as that sold under the brand name VASELINE, to at least a portion of a support, such as pole or string supporting a bird feeder or birdhouse. The method may alternatively or additionally include applying the lubricant directly to the bird feeder, birdhouse or other location itself.

### EXAMPLE 1

The inventor of this application successfully prevented squirrels from accessing a bird feeder mounted on a pole, by applying petroleum jelly to the pole and to the ground around the pole. At present, it is unknown precisely why this method was effective, but it is hypothesized that the effect came from a reduction of the coefficient of friction of the pole through the application of the lubricant, making it too difficult for squirrels to climb the pole, and/or from a natural aversion to petroleum jelly on the part of the squirrels, e.g., an aversion to the smell and/or feel of it.

### EXAMPLE 2

It is expected that a similar effect could be obtained for a bird feeder or birdhouse of the type suspended from a string or rope, by applying the lubricant to the string or rope.

It is expected that similar desirable effects could be achieved by using lubricants other than petroleum jelly, such as lithium grease or other types of grease, vegetable oil or other types of oil, silicone-based lubricants, graphite-based lubricants, or the like. Advantages of petroleum jelly include low cost, cleanliness, non-toxicity and long-lasting adhesion to, e.g., a pole or a string supporting a bird feeder.

While the invention has been described in conjunction with the exemplary embodiments, these embodiments should be viewed as illustrative, not limiting. Various modifications, substitutes, or the like are possible within the spirit and scope of the invention.

What is claimed is:

1. A method for guarding a location attractive to an animal against access by the animal, comprising:
applying a lubricant on and/or around a support that supports the location that is attractive to the animal.

2. The method of claim 1, wherein the location is a bird feeder or a birdhouse.

3. The method of claim 1, wherein the support is a pole supporting the location.

4. The method according to claim 1, wherein the support is a string from which the location is suspended.

5. The method of claim 1, wherein the lubricant is petroleum jelly.

6. A product, comprising:
a lubricant, and
a set of instructions for performing the method of claim 1.

7. The product according to claim 6, where the lubricant comprises petroleum jelly.
